(19) United States
(12) Patent Application Publication
(10) Pub. No.: US 2004/0012970 A1
(43) Pub. Date: Jan. 22, 2004

(54) Lamp protection device

(75) Inventors: Yin-Chun Huang, Hsin-Chu City (TW); Shu-Ya Chiang, Taichung City (TW); Po-Hua Fang, Yung-Ho City (TW)

Correspondence Address: LOWE, HAUPTMAN, GOPSTEIN & BERNER, LLP, Suite 310, 1700 Diagonal Road, Alexandria, VA, 22314, US

(73) Assignee: UMAX DATA SYSTEMS INC.

(21) Appl. No.: 10/198,136

(22) Filed: Jul. 19, 2002

(51) Int. Cl. F21V 15/04

(52) U.S. Cl. 362/390; 362/369

(57) ABSTRACT

A lamp protection device of an optical image scanner is disclosed. The lamp protection device comprises a chassis having a lamp holder and a lamp therein and buffer means for absorbing shock on lamp. The chassis moves under a transparent sheet of the optical image scanner and scan a document places on the transparent sheet. The buffer means for absorbing shock on lamp contact and provides the lamp with damping when said chassis end scanning and is locked.

### BACKGROUND OF THE INVENTION

1. Field of the Invention

The present invention relates to a lamp protection device, and more particularly to a device for protecting a cold-cathode fluorescent lamp in an image scanner.

2. Description of the Related Art

Optical scanners are used to capture and digitize images. For example, an optical scanner can be used to capture the image of printed matter on a sheet of paper. The digitized image can then be electronically stored and/or processed with character recognition software to produce ASCII text. In an optical image scanner, a chassis is a very important and expensive sub-assembly as it carries a lamp set, reflection means, lens set and charge-coupled devices (CCD). During scanning operation, the chassis should remain movable. However, during transportation of the scanner, the chassis should be locked stationary to avoid vibration or impact force of movement in damaging the parts located therein. It is the lamp, especially a cold-cathode fluorescent lamp, that particularly needs to be well protected since it is so fragile and so crucial. Therefore a conventional optical image scanner usually has a locking means for this purpose. However, the conventional locking means can only lock and prevent the chassis from vibration and moving while the image scanner is being transported, it still cannot provide a effective protection for the fragile lamp FIG. 1A shows a conventional optical image scanner 100. The optical image scanner 100 comprises a glass 102, an up housing 104, a down housing 106 and a chassis 108. FIG. 1B shows the detail of the chassis 108. The chassis 108 comprises a lamp holder 110 having a lamp 118, a mirror 112, a lens means 114 and a charge-coupled device module 116. FIG. 1C shows the detail of the lamp holder 110.

Referring to FIG. 1A, the chassis 108 moves back and forth under the glass 102 so as to scan and receive the image of a document placed on the glass 102 while the image scanner 100 is scanning. After the scanning is completed, the chassis 108 moves back and is then locked by a locking means (not shown). Although the chassis 108 is locked and fixed by the locking means, the fragile lamp 118 on the lamp holder 110 may not be fixed well as the chassis 108. Even the lamp 118 is fixed, it still could be broke during transportation or collision since it is so fragile and thin. For example, the diameter of a modern cold-cathode fluorescent lamp is about 1.8 millimeter to about 2.6 millimeter. Furthermore, as shown in FIGS. 1B and 1C, stress on the lamp 118 is always applied from the lamp holder 110 during transportation or collision and the lamp 118 is usually broke because of this unbalanced stress. Therefore, it is desirable to provide a new device which can overcome the problem of the prior art and the device of this invention is the one.

### SUMMARY OF THE INVENTION

It is therefore an object of the invention to provide a lamp protection device which can prevent a lamp from breaking.

It is another object of this invention to provide a lamp protection device that can balance the stress of collision and transportation.

To achieve these objects, and in accordance with the purpose of the invention, the invention provide a lamp protection device of an optical image scanner. The lamp protection device comprises a chassis having a lamp holder and a lamp therein and buffer means for absorbing shock on lamp. The chassis moves under a transparent sheet of the optical image scanner and scan a document places on the transparent sheet. The buffer means for absorbing shock on lamp contact and provide the lamp with damping and protection when the chassis end scanning and is locked.

In another embodiment of this invention, the lamp protection device comprises a chassis having a lamp holder and a lamp therein and an up housing of the optical image scanner for absorbing shock on lamp. The chassis moves under a transparent sheet of the optical image scanner and scan a document places on the transparent sheet. The up housing for absorbing shock on lamp contacts and provides the lamp with damping and protection when the chassis end scanning and is locked.

It is to be understood that both the foregoing general description and the following detailed description are exemplary and explanatory only and are not restrictive of the invention, as claimed.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A shows a schematic diagram of a conventional optical image scanner;

FIG. 1B shows the detail of the chassis shown in FIG. 1A;

FIG. 1C shows the detail of the lamp holder shown in FIG. 1B;

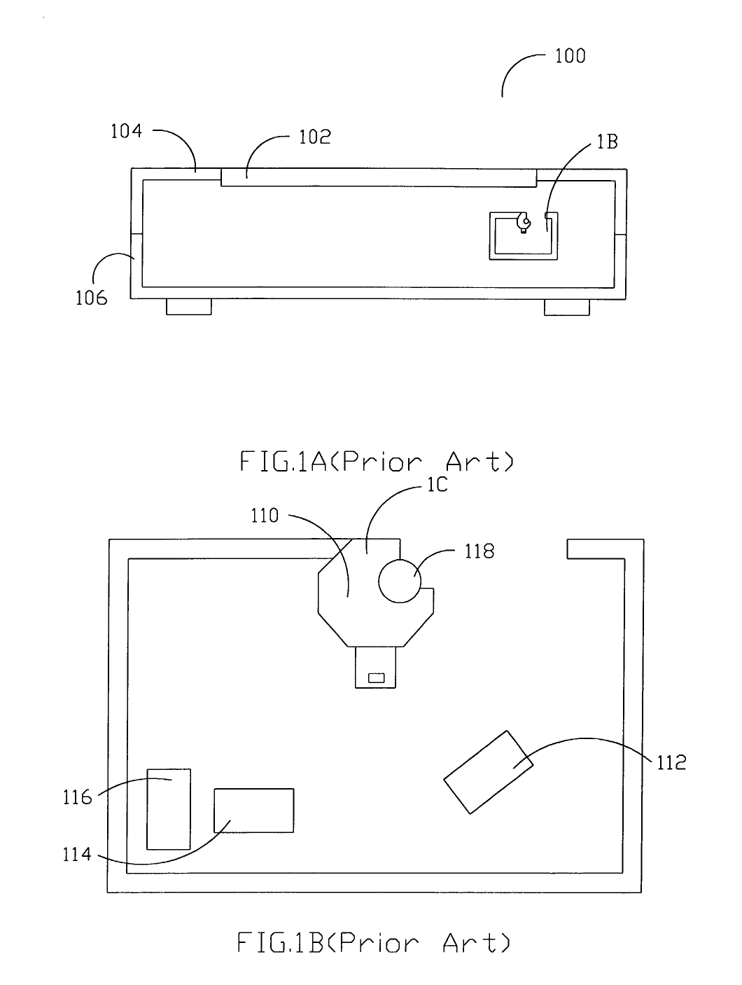

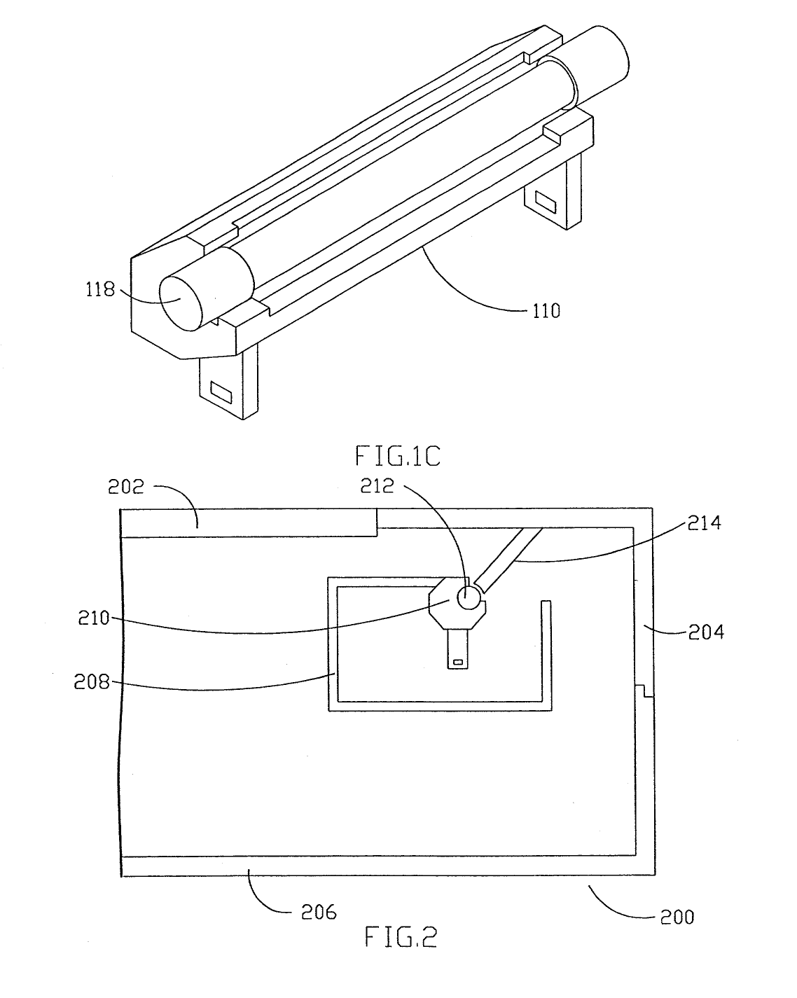

and FIG. 2 shows an image scanner of this invention.

### DESCRIPTION OF THE PREFERRED EMBODIMENT

It is to be understood and appreciated that the device described below do not cover a complete system. The present invention can be practiced in conjunction with various hardware that are used in the art, and only so much of the commonly practiced components and steps are included herein as are necessary to provide an understanding of the present invention.

The present invention will be described in detail with reference to the accompanying drawings. It should be noted that the drawings are in greatly simplified form.

Referring to FIG. 2, an image scanner 200 of this invention is shown. The image scanner 200 comprises a transparent sheet 202 such as a glass sheet, an up housing 204, a down housing 206, a chassis 208 and a buffer means for absorbing shock on lamp 214. The chassis 208 comprises a lamp holder 210 and a lamp 212 on the lamp holder 210. The buffer means for absorbing shock on lamp 214 can be, for example, a long strip with one side of sponge which contacts and protects the lamp 212. The buffer means for absorbing shock on lamp 214 can be made of the same material with the up housing 204 and down housing 206. The buffer means for absorbing shock on lamp 214 can also be a part of the up housing 214. The buffer means for absorbing shock on lamp 214 provide the lamp 212 with a damping and protection when the chassis 208 moves back and is locked by a locking means after scanning. During transportation or undesired collision, the buffer means for absorbing shock on lamp 214 acts as a shock absorber.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claim is:

1. A lamp protection device of an optical image scanner, said lamp protection device comprising:
a chassis having a lamp holder and a lamp therein, said chassis moves under a transparent sheet of the optical image scanner and scan a document places on the transparent sheet;
buffer means for absorbing shock on lamp, said buffer means for absorbing shock on lamp contact and provide said lamp with damping and protection when said chassis end scanning and is locked.

2. The lamp protection device according to claim 1, wherein said lamp comprises a cold-cathode fluorescent lamp.

3. The lamp protection device according to claim 1, wherein said buffer means for absorbing shock on lamp comprise a long strip with one side of sponge which contacts and protects said lamp by providing damping.

4. A lamp protection device of an optical image scanner, said lamp protection device comprising:
a chassis having a lamp holder and a lamp therein, said chassis moves under a transparent sheet of the optical image scanner and scan a document places on the transparent sheet;
buffer means for absorbing shock on lamp located on an up housing of the optical image scanner, said buffer means for absorbing shock on lamp contact and provide said lamp with damping and protection when said chassis end scanning and is locked.

5. The lamp protection device according to claim 4, wherein said buffer means for absorbing shock on lamp comprise a long strip with one side of sponge which contacts and protects said lamp by providing damping.

6. A lamp protection device of an optical image scanner, said lamp protection device comprising:
a chassis having a lamp holder and a lamp therein, said chassis moves under a transparent sheet of the optical image scanner and scan a document places on the transparent sheet;
an up housing of the optical image scanner for absorbing shock on lamp, said up housing for absorbing shock on lamp contacts and provides said lamp with damping and protection when said chassis end scanning and is locked.

7. The lamp protection device according to claim 6, wherein said up housing for absorbing shock on lamp comprises a long strip with one side of sponge which contacts and protects said lamp by providing damping.
